(19) United States
(12) Patent Application Publication
(10) Pub. No.: US 2018/0335136 A1
(43) Pub. Date: Nov. 22, 2018

(54) Shift Actuator Assemblies And Control Methods For A Ball-Type Continuously Variable Planetary Transmission

(71) Applicant: Dana Limited, Maumee, OH (US)

(72) Inventor: Jeffrey M. David, Cedar Park, TX (US)

(21) Appl. No.: 15/985,910

(22) Filed: May 22, 2018

Related U.S. Application Data
(60) Provisional application No. 62/509,393, filed on May 22, 2017.

(51) Int. Cl. F16H 61/664; F16H 15/50; F16H 63/16; F16H 63/30

(52) U.S. Cl. CPC F16H 61/664; F16H 63/304; F16H 63/16; F16H 15/503

(57) ABSTRACT

A vehicle including: a CVP having a first traction ring and a second traction ring in contact with a plurality of balls, wherein each ball o has a tiltable axis of rotation and is supported in a carrier assembly having a first carrier member and a second carrier member, wherein a relative position of the first carrier member with respect to the second carrier member guides the tiltable axis of rotation; an electric shift actuator operably coupled to the carrier assembly, the electric shift actuator having a first rotor coupled to the first carrier member and a second rotor coupled to the second carrier member, wherein the first rotor is aligned with a first stator and the second rotor is aligned with a second stator; and a controller configured to control the electric shift actuator and a phase angle between the first rotor and the second rotor.

### RELATED APPLICATION

This application claims the benefit of U.S. Provisional Application No. 62/509,393 filed May 22, 2017, which is incorporated herein by reference in its entirety.

### BACKGROUND

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY

Provided herein a vehicle having: a continuously variable planetary (CVP) having a first traction ring and a second traction ring in contact with a plurality of balls, wherein each ball of the plurality of balls has a tiltable axis of rotation, each ball is supported in a carrier assembly having a first carrier member and a second carrier member, wherein a relative position of the first carrier member with respect to the second carrier member guides the tiltable axis of rotation; an electric shift actuator operably coupled to the carrier assembly, the electric shift actuator having a first rotor coupled to the first carrier member and a second rotor coupled to the second carrier member, wherein the first rotor is aligned with a first stator and the second rotor is aligned with a second stator; and a controller configured to control the electric shift actuator, wherein the controller controls a phase angle between the first rotor and the second rotor.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a block diagram of a vehicle control system implementing the variator of FIG. 1.

FIG. 5 is a schematic diagram of a hybrid-electric powertrain having a ball-type variator, an engine, and two electric motor/generators.

FIG. 6 is a cross-section view of a ball-type variator having an electric shift actuator integral to a carrier of the variator.

FIG. 7 is a schematic diagram of another hybrid-electric powertrain having a ball-type variator, an engine, and two electric motor/generators.

FIG. 8 is a cross-sectional view of a ball-type variator having an electric shift actuator integral to the carrier of the variator.

FIG. 9 is a block diagram of a carrier phase controller that is implementable in the vehicle control system of FIG. 4.

FIG. 10 is a block diagram of the carrier phase controller of FIG. 9.

FIG. 11 is a block diagram of a torque based PID phase controller that is implemented in the carrier phase controller of FIG. 10.

FIG. 12 is a block diagram of a speed based PID phase controller that is implemented in the carrier phase controller of FIG. 10.

FIG. 13 is a block diagram of a motor controller that is implementable in the vehicle control system of FIG. 4.

FIG. 14 is a block diagram of a torque reference algorithm that is implementable in the vehicle control system of FIG. 4.

### DETAILED DESCRIPTION OF THE PREFERRED EMBODIMENTS

A control process is described herein that enables electronic control over a variable ratio transmission having a continuously variable ratio portion, such as a Continuously Variable Transmission (CVT), Infinitely Variable Transmission (IVT), or variator. In some embodiments, an electronic controller is configured to receive input signals indicative of parameters associated with an engine coupled to the transmission. The parameters includes throttle position sensor values, accelerator pedal position sensor values, vehicle speed, gear selector position, user-selectable mode configurations, and the like, or some combination thereof. The electronic controller also receives one or more control inputs. The electronic controller determines an active range and an active variator mode based on the input signals and control inputs. The electronic controller controls a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “BALL-TYPE CVT/IVT INCLUDING PLANETARY GEAR SETS,” and U.S. patent application Ser. No. 15/572,288, entitled “CONTROL METHOD FOR SYNCHRONOUS SHIFTING OF A TRANSMISSION COMPRISING A CONTINUOUSLY VARIABLE PLANETARY MECHANISM”, each assigned to the assignee of the present application and hereby incorporated by reference herein in its entirety. However, the electronic controller is not limited to controlling a particular type of transmission but optionally configured to control any of several types of variable ratio transmissions.

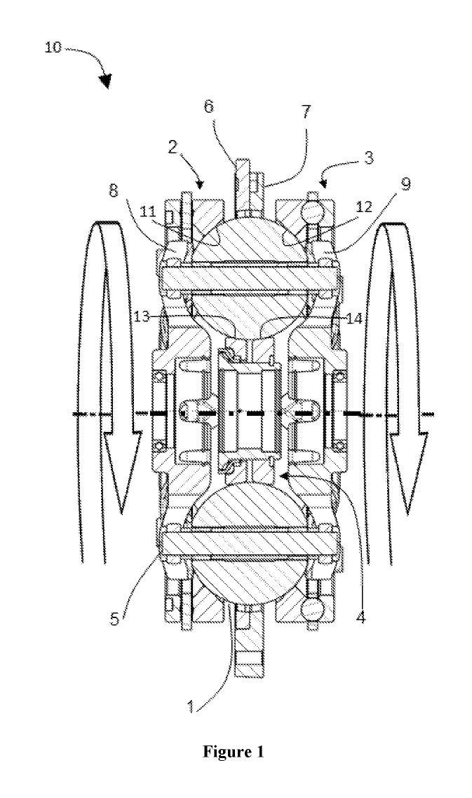

Provided herein are configurations of CVTs based on ball-type variators, also known as CVP, for continuously variable planetary. Basic concepts of a ball-type Continuously Variable Transmissions are described in U.S. Pat. No. 8,469,856 and U.S. Pat. No. 8,870,711 incorporated herein by reference in their entirety. In some embodiments, a CVP 10, adapted herein as described throughout this specification, includes a number of balls (planets, spheres) 1, depending on the application, two ring (disc) assemblies with a conical surface contact with the balls 1, as a first traction ring 2 and a second traction ring 3, and an idler (sun) assembly 4 as shown on FIG. 1. The balls 1 are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9. The radial guide slots 8 and the radially offset guide slots 9 are adapted to guide the tiltable axles 5. The axles 5 is adjusted to achieve a desired ratio of input speed to output speed during operation of the CVP 10.

In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

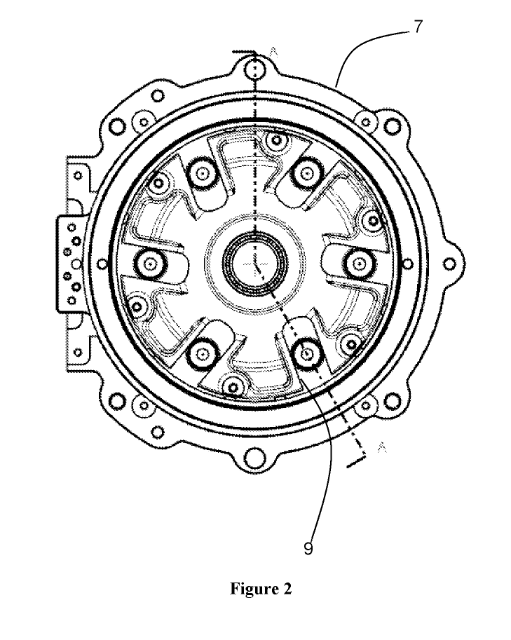

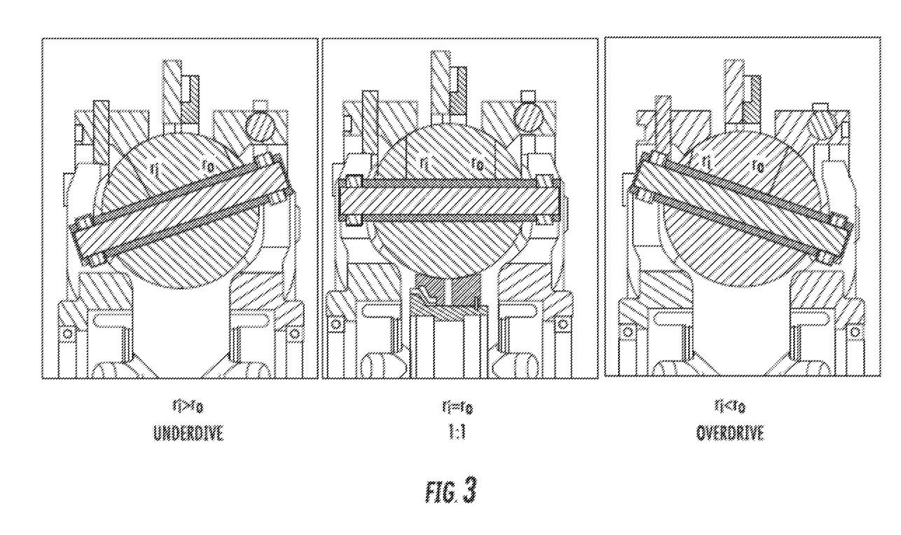

The working principle of such the CVP 10 of FIG. 1 is shown in FIGS. 2-3. The CVP itself works with a traction fluid. The lubricant between the ball and the conical rings acts as a solid at high pressure, transferring the power from the input ring, through the balls, to the output ring. As used herein, the term “traction contact” refers to the area between contacting components. For example, a first traction contact 11 is formed between the first traction ring 2 and the ball 1; the second traction contact 12 is formed between the second traction ring 3 and the ball 1; the third contact 13 is formed between the sun assembly 4 and the ball 1; and the fourth contact 14 is formed between the sun assembly 4 and the ball 1. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler.

Embodiments disclosed here are related to the control of a variator and/or a CVT using generally spherical planets each having a tiltable axis of rotation that is capable of being adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, ramped surface 52A and ramped surface 52B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. In some embodiments, the traction coefficient is a design parameter in the range of 0.3 to 0.6. Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, solar, geothermal, hydraulic, and/or pneumatic, to name but a few. Although typically described in a vehicle or automotive application, one skilled in the art will recognize the broader applications for this technology and the use of alternative power sources for driving a transmission comprising this technology.

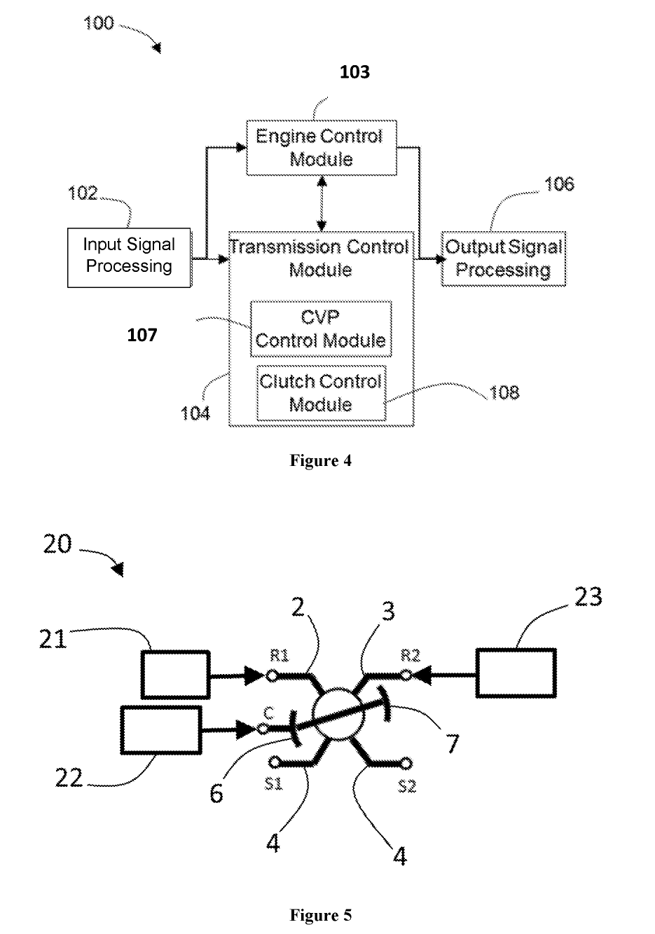

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others.

In some embodiments, the input signal processing module 102 optionally includes various sub-modules to perform routines such as signal acquisition, signal arbitration, or other known methods for signal processing. The output signal processing module 106 is optionally configured to electronically communicate to a variety of actuators and sensors.

In some embodiments, the output signal processing module 106 is configured to transmit commanded signals to actuators based on target values determined in the transmission control module 104.

The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission.

In some embodiments, the clutch control sub-module 108 implements state machine control for the coordination of engagement of clutches or similar devices.

The transmission control module 104 optionally includes a CVP control sub-module 107 programmed to execute a variety of measurements and determine target operating conditions of the CVP, for example, of the ball-type continuously variable transmissions discussed here. It should be noted that the CVP control sub-module 107 optionally incorporates a number of sub-modules for performing measurements and control of the CVP.

In some embodiments, the vehicle control system 100 includes an engine control module 103 configured to receive signals from the input signal processing module 102 and in communication with the output signal processing module 106. The engine control module 103 is configured to communicate with the transmission control module 104.

Referring now to FIG. 5, in some embodiments, a hybrid-electric powertrain 20 includes the variator described in FIGS. 1-3, and shown schematically for description purposes. The hybrid-electric powertrain 20 includes an internal combustion engine (ICE) 21 operably coupled to the first traction ring 2, a first motor/generator (EM1) 22 operably coupled to the first carrier member 6 and the second carrier member 7, and a second motor/generator (EM2) 23 operably coupled to the second traction ring 3. During operation of the hybrid-electric powertrain 20, rotational power is provided by any one of the engine 21, the first motor/generator 22, and/or the second motor/generator 23.

In some embodiments, the first motor/generator 22 is configured to provide control of speed ratio of the variator.

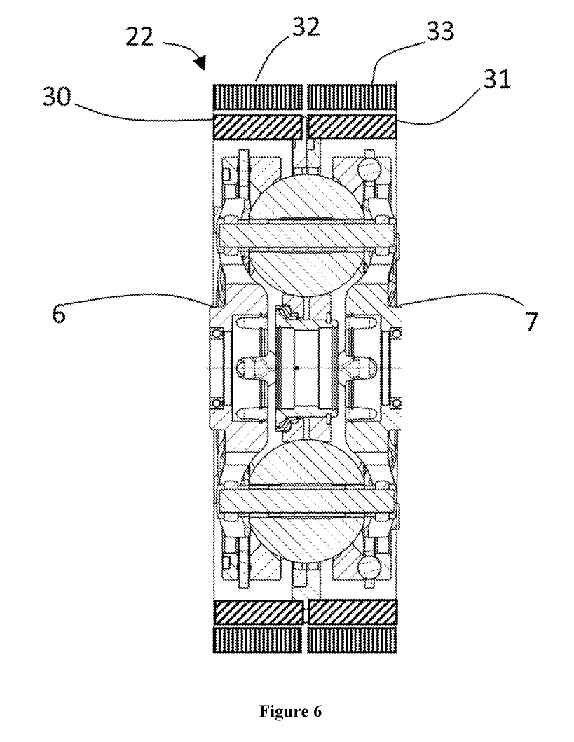

Referring now to FIG. 6, in some embodiments, the first motor/generator 22 includes a first rotor 30 coupled to the first carrier member 6 and a second rotor 31 coupled to the second carrier member 7. The first rotor 30 is configured to electrically couple to a first stator 32. The second rotor 31 is configured to electrically couple to a second stator 33. During operation of the first motor/generator 22, a phasing between the first rotor 30 and the second rotor 31 corresponds to a relative rotation between the first carrier member 6 and the second carrier member 7. As discussed previously, the angular rotation between the first carrier member 6 and the second carrier member 7 provides speed ratio control of the variator.

In some embodiments, the first carrier member 6 and the second carrier member 7 are provided with physical hard stops such that that angular rotation between the two carrier members is limited to only that which is necessary for full ratio range. In some embodiments, each independent carrier member is circular with either permanent magnets or an induction motor rotor cage embedded in the outer flange thereof. This forms a twin section rotor for the first motor/generator 22. Similarly, the stator for the first motor/generator 22 and associated windings of the electric machine are split into the first stator 32 and the second stator 33, arranged such that two independent motor sections with an appropriate air gap are maintained. Thus, the first rotor 30 and the second rotor 31 are combined to provide ratio control actuation for the carrier assembly.

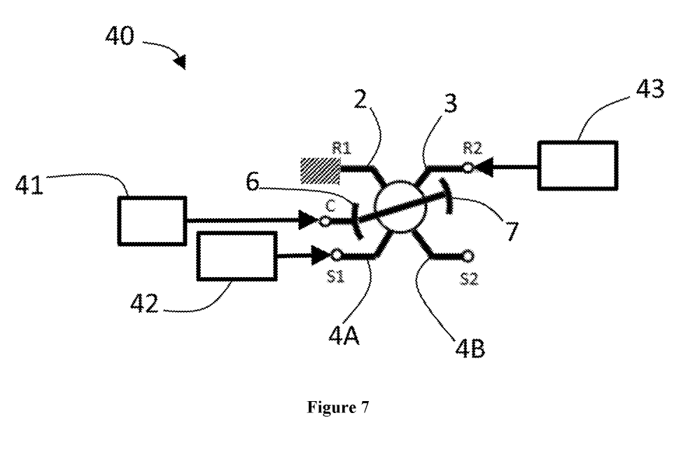

Turning now to FIG. 7, in some embodiments, a hybrid-electric powertrain 40 includes the variator described in FIGS. 1-3. In some embodiments, the hybrid-electric powertrain 40 includes an internal combustion engine (ICE) 41 operably coupled to the first carrier member 6, a first motor/generator (EM1) 42 operably coupled to the first sun member 4A, and a second motor/generator (EM2) 43 operably coupled to the second traction ring 3. The first traction ring 2 is grounded to a non-rotatable component of the variator, such as a housing (not shown). During operation of the hybrid-electric powertrain 40, rotational power is provided by any one of the engine 41, the first motor/generator 42, and/or the second motor/generator 43.

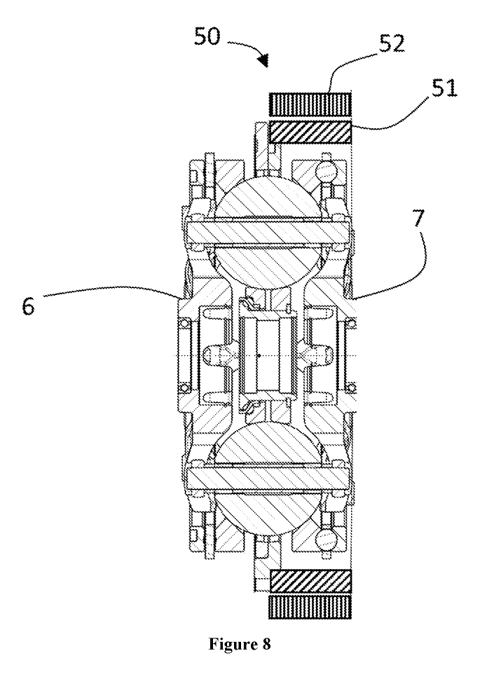

Referring now to FIG. 8, in some embodiments, an electric shift actuator 50 is operably coupled to the second carrier member 7. The electric shift actuator 50 includes a rotor 51 coupled to the second carrier member 7. The rotor 51 is configured to electrically couple to a stator 52. The engine 41 transmits rotational power to the first carrier member 6. The electric shift actuator 50 is configured to control the relative position of the second carrier member 7 with respect to the first carrier member 6.

In some embodiments, magnets or induction motor rotor cage bars are imbedded in the radial edge of the rotor 51. A single stator section with an appropriate air gap is utilized to generate torque for ratio change.

In other embodiments, a disconnect clutch (not shown) is provided to selectively engage the engine 41 to the first carrier member 6. In said embodiment, the integrated electric machine to the carrier assembly optionally consists of a two section stator as depicted in FIG. 6. This allows the electric motor/generator, such as the electric motor/generator 42, to control ratio when the engine is off and disconnected, for example, the ratio control machine can simultaneously provide torque and control ratio.

Additionally, embodiments provided with a disconnect clutch between the engine 41 and the first carrier member 6 are able to use the electric machine with the engine on to supplement or replace engine torque under advantageous conditions.

In yet other embodiments, a grounding clutch is operably coupled to one of the first carrier member 6 or the second carrier member 7 for certain powerpath configurations. Ratio control is then a matter of providing the necessary shift torque on the free carrier using only one section of the rotor.

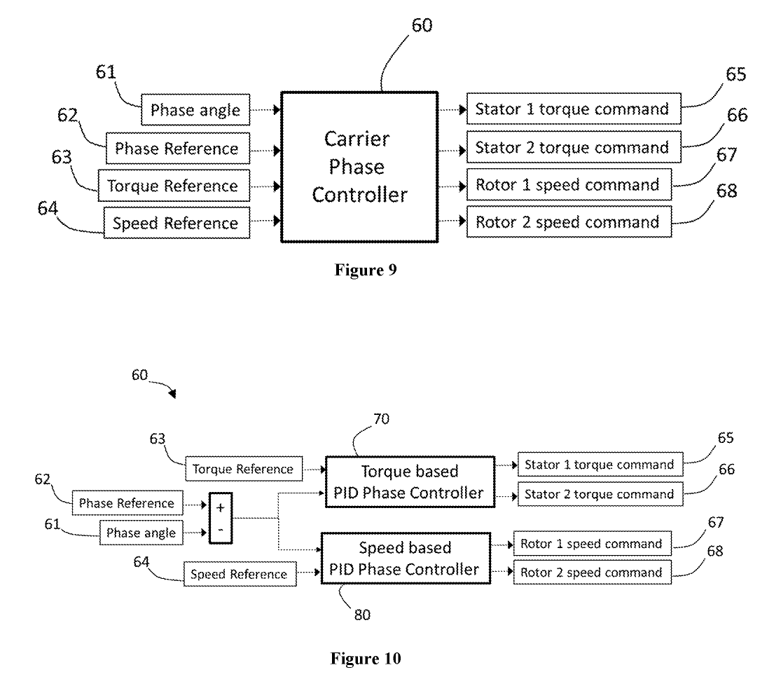

Turning now to FIGS. 9-14, a basic controls concept for the electric machine and electric shift actuator described herein, is to provide the total required electric machine torque (for tractive effort, engine speed control, regenerative braking, etc.) from the sum of the torque production of each independent section while simultaneously providing CVP ratio control by balancing the torque split between the two sections. Equations to accomplish this are as follows.

T_{EM1}=T_{C1}+T_{C2}+T_{shift}
T_{EM1}=total electric machine torque
T_{C1}=required first carier member torque, f(T_{engine}, road load, current ratio)
T_{C2}=required second carier member torque, f(T_{engine}, road load, current ratio)
T_{shift}=torque addition or subtraction from either carrier for ratio change

As can be seen from the math when the individual section torques are balanced for the current operating conditions, the ratio is not changing. Ratio change is accomplished by adding or subtracting from the required torque relative to the current operating conditions. This creates an intentional imbalance and forces a ratio change.

An expanded equation for carrier shift torque (Tshift) is shown below with terms representing dampener spring force (kθ), carrier inertial effects (Jθ), and base carrier shift force (f(T_{carrier},θ)), respectively.

In some embodiments, the base carrier shift force is determined by a method described in U.S. patent application Ser. No. 15/939,526, which is hereby incorporated by reference.

In some embodiments, a torsion spring is coupled to one or both of the first carrier member 6 or the second carrier member 7. Torsion spring force can either assist with shifting or impede shifting based on selection of default position. Carrier inertial effects are related to desired shift rates.

T_{shift}=kθ+J\ddot{θ}+f(T_{carrier},θ)
θ=carrier angular position (rad)
\ddot{θ}=carrier angular accleleration (rad/s²)
J=carrier inertia (kg m²)
k=torsional spring constant (Nm/rad)

During operation, the carrier shift force is based on current operating conditions and is converted to a torque and added to the torsional spring and inertia terms to arrive and the final shift torque requirements by the vehicle control system 100, for example.

Referring now to FIGS. 9 and 10, in some embodiments, a carrier phase controller 60 is configured to receive a number of signals from, for example, the vehicle control system 100. The signals include a phase angle 61, a phase reference 62, a torque reference 63, and a speed reference 64. The carrier phase controller 60 determines a first stator torque command 65, a second stator torque command 66, a first rotor speed command 67, and a second rotor speed command 69.

In some embodiments, the carrier phase controller 60 includes a torque based PID phase controller 70 and a speed based PID phase controller 80. Typically, a PID controller, otherwise known as a proportional-integral-derivative controller, is configured for receiving a difference between a set point and a controlled variable of a process to be controlled and delivering a manipulated variable to the process, the process being operated by the manipulated variable to produce the controlled variable.

In some embodiments, the difference between the phase angle 61 and the phase angle reference 62 is provided to the torque based PID phase controller 70 and the speed based PID phase controller 80. In some embodiments, the carrier phase controller 60 is implemented in the CVP control module 107.

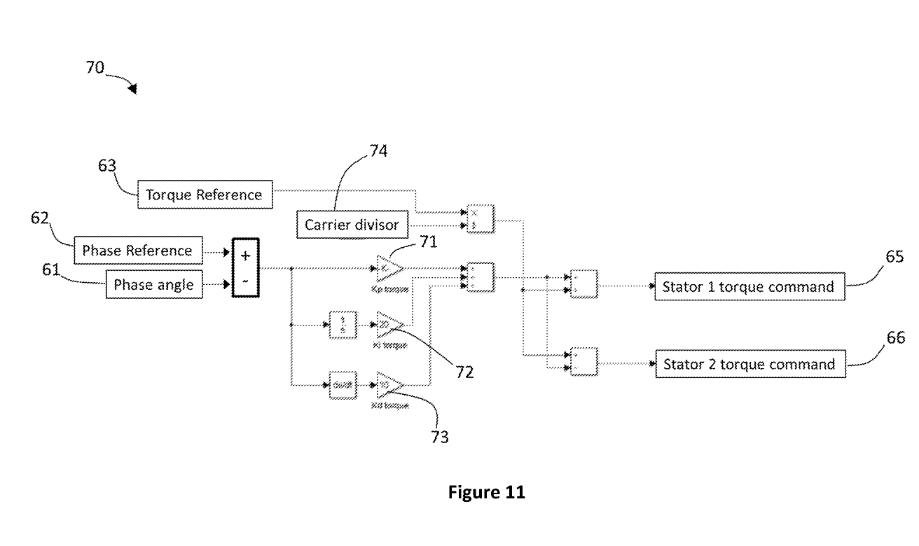

Passing now to FIG. 11, in some embodiments, the torque based PID phase controller 70 includes a number of calibrateable variables to tune the control response, sometimes referred to as the PID gains. The torque based PID phase controller 70 includes a proportional gain constant 71, an integral gain constant 72, and a derivative gain constant 73. The proportional gain constant 71 is multiplied by the difference between the phase reference 62 and the phase angle 61. The integral gain constant 72 is multiplied by the integral of the difference between the phase reference 62 and the phase angle 61. The derivative gain constant 73 is multiplied by the derivative of the difference between the phase reference 62 and the phase angle 61 to form products. The said products are summed and then added to the product of the reference torque command 63 divided by the carrier divisor 74 to form the first stator torque command 65. The said products are subtracted from the product of the reference torque command 63 divided by the carrier divisor 74 to form the second stator torque command 66. A carrier divisor 74 is a calibrateable parameter to determine the division of the torque reference 63 between the first stator 32 and the second stator 33, for example.

In some embodiments, the carrier divisor 74 is two, indicating that the torque reference 63 is split evenly between the first stator 32 and the second stator 33.

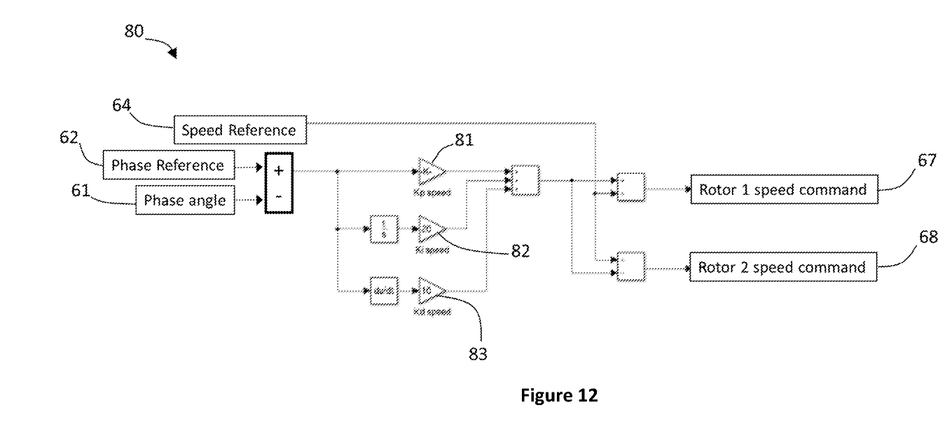

Turning now to FIG. 12, in some embodiments, the speed based PID phase controller 80 includes a proportional gain constant 81, an integral gain constant 82, and a derivative gain constant 83. The proportional gain constant 81 is multiplied by the difference between the phase reference 62 and the phase angle 61. The integral gain constant 82 is multiplied by the integral of the difference between the phase reference 62 and the phase angle 61. The derivative gain constant 83 is multiplied by the derivative of the difference between the phase reference 62 and the phase angle 61. The said products are summed and added to the speed reference 64 to form the first rotor speed command 67 and subtracted from the speed reference 64 to form the second rotor speed command 69.

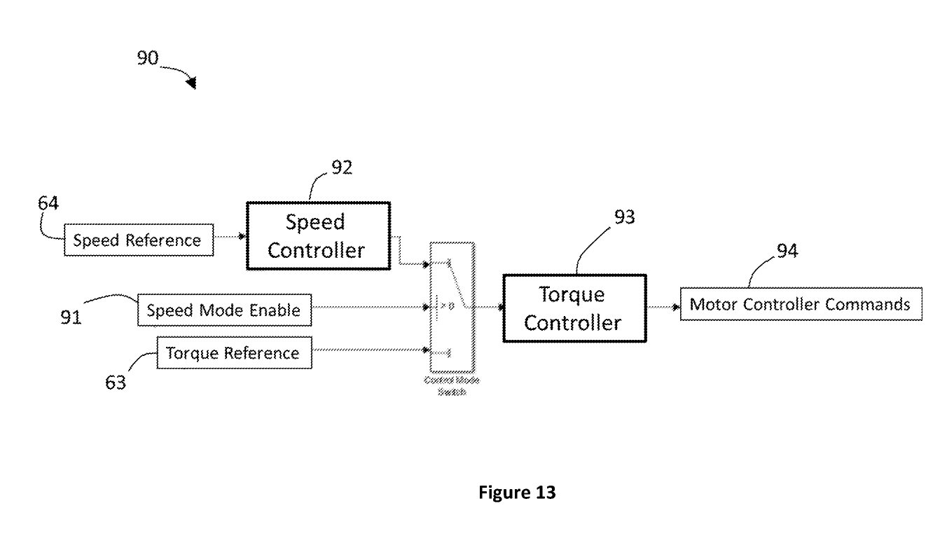

Referring now to FIG. 13, basic electric machine speed control generally functions by converting a speed error into a torque reference command. It should be appreciated that the carrier phase controller 60, as well as other controllers described herein, are optionally configured to receive an actual speed signal and an actual torque signal from the vehicle control system 100 to use in control processes, for example, in determining an error between the actual speed and the desired speed, or an error between the actual torque and the desired torque, as is typically done in feedback control systems. Therefore, when in torque control the speed control portion is bypassed and the torque reference is passed directly into the torque controller. Otherwise, when in speed control the speed reference is converted to a torque reference and passed on as shown in the FIG. 13.

In some embodiments, a motor controller 90 is implementable in the vehicle control system 100, for example. The motor controller 90 includes a speed controller 92 and a torque controller 93. The speed controller 92 is adapted to receive a speed reference 64 and determine a torque reference based on the speed reference 64. An enable signal 91 is used to switch between the torque reference determined by the speed controller 92 and the torque reference 63. The switch passes the selected signal to a torque controller 93 that determines a motor controller command 94. In some embodiments, the motor controller command 94 is a multidimensional signal.

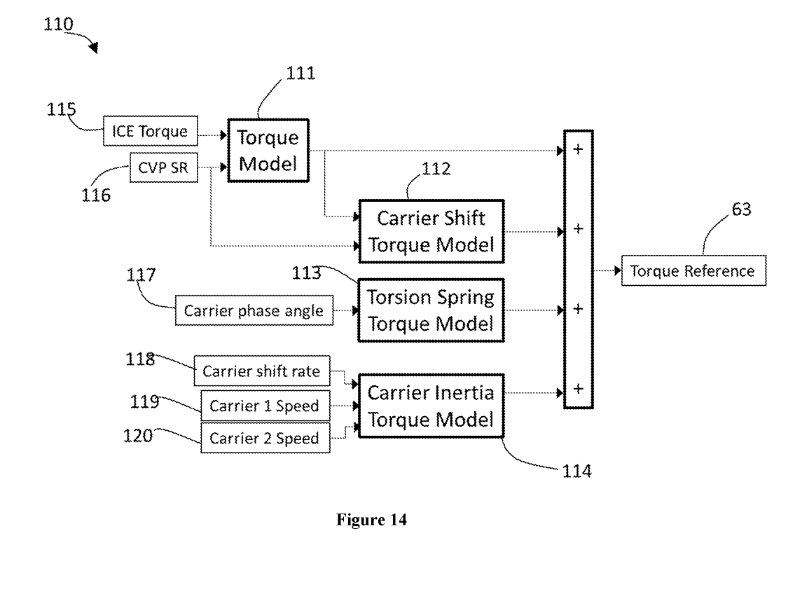

Referring now to FIG. 14, in some embodiments, the torque reference 63 is determined by a summation of a number of torque components in the system. As discussed herein, the total required torque for the electric machine, for example the first motor/generator 22, includes the tractive effort, engine speed control, regenerative braking, etc., from the sum of the torque production of each independent motor section while simultaneously providing CVP ratio control by balancing the torque split between the two sections.

In some embodiments, a torque reference process 110 includes a torque model 111, a carrier shift torque model 112, a torsion spring torque model 113, and a carrier inertia torque model 114. The torque model 111 receives an engine torque 115 and a CVP speed ratio 116 to determine a required torque on the first carrier member 6 and the second carrier member 7, sometimes referred to herein as a carrier torque. The torque model 111 passes the carrier torque to the carrier shift torque model 112 that determines a torque required to shift the CVP based on the CVP speed ratio 116 and the carrier torque. The torsion spring torque model 113 determines a spring torque based on the carrier phase angle 117. The carrier inertia torque model 114 determines a carrier inertia torque based on a carrier shift rate 118, a first carrier member speed 119, and a second carrier member speed 120.

Provided herein is a computer-implemented method for controlling an electric hybrid powertrain having a ball-planetary variator (CVP) provided with a ball in contact with a first traction ring, a second traction ring, each ball supported in a carrier assembly having a first carrier member and a second carrier member, the method including the steps of: coupling an electric shift actuator to the carrier assembly, wherein the electric shift actuator includes a first electric rotor coupled to the first carrier member, a second electric rotor coupled to the second carrier member, a first electric stator aligned with the first electric rotor, and a second electric stator aligned with the second electric rotor; receiving a plurality of data signals provided by sensors located on the electric hybrid powertrain, the plurality of data signals including: a CVP speed ratio, an input speed, and an input torque; determining a phase angle based on the CVP speed ratio; determining a speed reference based on the input speed; determining a torque reference based on the input torque; and delivering a motor command based on the torque reference.

In some embodiments, the method further includes determining a phase angle error based on the phase angle and a phase angle reference, wherein the phase angle reference is indicative of a commanded CVP speed ratio.

In some embodiments, the method further includes comprising determining a first stator torque command and a second stator torque command based on the phase angle error.

In some embodiments, the method further includes determining a first rotor speed command and a second rotor speed command based on the phase angle error.

Provided herein is an electric shift actuator for a ball-planetary variator (CVP) provided with a ball in contact with a first traction ring, a second traction ring, each ball supported in a carrier assembly having a first carrier member and a second carrier member, the electric shift actuator including: a first electric rotor coupled to the first carrier member; a second electric rotor coupled to the second carrier member; a first electric stator aligned with the first electric rotor; and a second electric stator aligned with the second electric rotor, wherein the first electric rotor and the first electric stator are adapted to operate as a first section of a motor/generator, wherein the second electric rotor and the second electric stator are adapted to operate as a second section of the motor/generator, and wherein a phase angle between the first section and the second section corresponds to a relative position of the first carrier member to the second carrier member.

In some embodiments, the phase angle corresponds to a speed ratio.

In some embodiments, the motor/generator is adapted to transmit rotational power to and from the CVP.

The foregoing description details certain embodiments. It will be appreciated, however, that no matter how detailed the foregoing appears in text, the embodiments can be practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A vehicle comprising:
a continuously variable planetary (CVP) having a first traction ring and a second traction ring in contact with a plurality of balls, wherein each ball of the plurality of balls has a tiltable axis of rotation, each ball is supported in a carrier assembly having a first carrier member and a second carrier member, wherein a relative position of the first carrier member with respect to the second carrier member guides the tiltable axis of rotation;
an electric shift actuator operably coupled to the carrier assembly, the electric shift actuator having a first rotor coupled to the first carrier member and a second rotor coupled to the second carrier member, wherein the first rotor is aligned with a first stator and the second rotor is aligned with a second stator; and
a controller configured to control the electric shift actuator,
wherein the controller controls a phase angle between the first rotor and the second rotor.

2. The vehicle of claim 1, wherein the phase angle corresponds to a relative rotation of the second carrier member with respect to the first carrier member.

3. The vehicle of claim 2, wherein the electric shift actuator is configured to transmit rotational power to the carrier assembly.

4. The vehicle of claim 2, wherein the controller determines a rotor speed command and a stator torque command based on the phase angle.

5. The vehicle of claim 2, wherein the controller further comprises a torque based PID phase controller and a speed based PID phase controller.
